(19) United States
(12) Patent Application Publication
(10) Pub. No.: US 2010/0214434 A1
(43) Pub. Date: Aug. 26, 2010

(54) APPARATUS AND METHOD FOR ADJUSTING WHITE BALANCE OF DIGITAL IMAGE

(75) Inventors: Ji-Hye Kim, Goyang-si (KR); Sung-Dae Cho, Yongin-si (KR); Min-Kyu Park, Seoul (KR); Hee-Chan Park, Seoul (KR); Jin-Ho Kim, Seoul (KR); Yun-Je Oh, Suwon-si (KR); Kyoung-Tae Kim, Nam-gu (KR); Choon-Woo Kim, Seoul (KR); Seul-Ki Jang, Bupyeong-gu (KR)

Correspondence Address: THE FARRELL LAW FIRM, LLP, 290 Broadhollow Road, Suite 210E, Melville, NY, 11747, US

(73) Assignees: Samsung Electronics Co., Ltd., Suwon-si (KR); Inha-Industry Partnership Institute, Incheon (KR)

(21) Appl. No.: 12/638,477

(22) Filed: Dec. 15, 2009

(30) Foreign Application Priority Data
Feb. 20, 2009 (KR) 10-2009-0014438

(51) Int. Cl. H04N 9/73

(52) U.S. Cl. 348/223.1; 348/655; 348/E09.051

(57) ABSTRACT

A method and an apparatus are provided for adjusting white balance of a digital image. An input image is converted into a YCbCr color space. White pixels of the converted input image are detected by determining whether each pixel of the converted input image is included in a preset region of the YCbCr color space. A gain of each channel is calculated from averages of R, G and B values of the detected white pixels. White balance adjustment is performed by applying the calculated gain of each channel to each pixel of the input image.

### PRIORITY

This application claims priority under 35 U.S.C. §119(a) to a Korean Patent Application filed in the Korean Intellectual Property Office on Feb. 20, 2009 and assigned Serial No. 10-2009-0014438, the entire disclosure of which is incorporated herein by reference.

### BACKGROUND OF THE INVENTION

1. Field of the Invention

The present invention relates generally to an apparatus and a method for processing a digital image, and more particularly, to an apparatus and a method for adjusting white balance of a digital image.

2. Description of the Related Art

An image device may perform white balance adjustment on images that it reproduces or photographs. The white balance adjustment affects the color of the image so that it is equal or similar to a color that a user has perceived.

A difference in color between the image and the user's perception can be caused by a light source illuminating a subject of the image or by an external background where the subject is photographed. Examples of the light source include, for example, sunlight, a fluorescent lamp, and incandescent lamp, etc. A user may not be aware of a variation in color despite a change in illumination or background, because the user adapts to these changes. However, since devices, such as digital cameras, are not capable of such an adaptation, a color perceived by the user, may be different from a color of an image.

Through white balance adjustment, an image having a color that is different from that perceived by the user is adjusted such that the color of the adjusted image is equal or similar to that perceived by the user. White balance adjustment is based on a white region of the image, and restores the white color, which was changed by the light source or the surrounding background, to the white color the user perceived.

White balance adjustment may be performed by two different methods. A first method estimates a type of background illumination used while photographing a subject and adjusts the white balance according to the estimation. This method searches for a white region(s) of an image. A gain of each channel is adjusted based on an average of image information or RGB values corresponding thereto, or an average of color difference signals (R-Y) and (B-Y). A second method, which does not estimate the type of illumination, adjusts a gain of each channel based on an average for each channel of the entire image. A color composed of an average for each channel is assumed to be white when an input image has a sufficient color variation. Specifically, it is possible to achieve white balance of an image by adjusting gains of RGB values of an image so that an average for each channel becomes equal.

In the first method of adjusting white balance by estimating a type of background illumination, searching for a white region of an image should precede all other steps. Therefore, this method is only able to adjust white balance when an input image includes a white region. If the white region of the image is not detected, white balance adjustment performance deteriorates.

Additionally, since the first method does not consider a characteristic of a sensor while photographing a subject, its performance after white balance adjustment is not high. Further, since this method uses one transformation matrix, or lookup table, during color matching after white balance adjustment regardless of the light source, the color may be viewed differently according to the light source.

### SUMMARY OF THE INVENTION

The present invention has been made to address at least the above problems and/or disadvantages and to provide at least the advantages described below. Accordingly, an aspect of the present invention provides a white balance adjustment apparatus and method for minimizing color distortion caused by light sources in an image with a white color.

According to one aspect of the present invention, a method for adjusting white balance of a digital image is provided. An input image is converted into a YCbCr color space. White pixels of the converted input image are detected by determining whether each pixel of the converted input image is included in a preset region of the YCbCr color space. A gain of each channel is calculated from averages of R, G and B values of the detected white pixels. White balance adjustment is performed by applying the calculated gain of each channel to each pixel of the input image.

According to another aspect of the present invention, an apparatus for adjusting white balance of a digital image is provided. The apparatus includes an image converter for converting an input image into a YCbCr color space. The apparatus also includes a white detector for detecting white pixels of the converted input image by determining whether each pixel of the converted input image is included in a preset region of the YCbCr color space. The apparatus further includes a gain calculator for calculating a gain of each channel from averages of R, G and B values of the detected white pixels. The apparatus additionally includes a white balance executer for performing white balance adjustment by applying the calculated gain of each channel to each pixel of the input image.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a block diagram of a white balance adjustment apparatus, according to an embodiment of the present invention;

FIG. 2 is a graph illustrating a relation between chrominance Cb and Cr of an image obtained by photographing gray patches of a Macbeth color checker for each light source, according to an embodiment of the present invention;

FIG. 3 is a graph illustrating a relation between chrominance |Cb|+|Cr| and luminance Y of an image obtained by photographing gray patches of a Macbeth color checker for each light source, according to an embodiment of the present invention;

FIG. 4 is a linear function graph illustrating a relation between chrominance |Cb|+|Cr| and luminance Y of an image obtained by photographing gray patches of a Macbeth color checker for each light source, according to an embodiment of the present invention;

FIG. 5 is a graph illustrating a slope range where white pixels are detected in a linear function graph modeled for white detection of an image during white balance adjustment, according to an embodiment of the present invention;

FIG. 6 is a diagram illustrating white detection results on each light source during white balance adjustment, according to an embodiment of the present invention;

FIG. 7 is a graph illustrating R, G and B gains of each light source, according to an embodiment of the present invention;

FIG. 8 is a diagram illustrating a process of making a color matching matrix applied during white balance adjustment, according to an embodiment of the present invention; and

FIG. 9 is a flowchart illustrating a white balance adjustment method, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

The embodiments of the present invention adjust white balance of a digital image to minimize color distortion that is caused by light sources and to improve image quality. The embodiments of the present invention convert an input image into a YCbCr color space. A linear function graph is modeled to indicate a relation between chrominance |Cb|+|Cr| and luminance Y of an image obtained by photographing 6 patches at the bottom of 24 patches of a Macbeth color checker for each light source. White pixels of the input image are detected using the modeled linear function graph. Further, embodiments of the present invention calculate R, G and B gains from R, G and B averages of the detected white pixels, adjust white balance using the calculated R, G and B gains, distinguish a light source based on a gain of a particular channel, and apply a color matching matrix corresponding to the distinguished light source. A white balance adjustment apparatus and method according to an embodiment of the present invention are described in detail with reference to accompanying drawings.

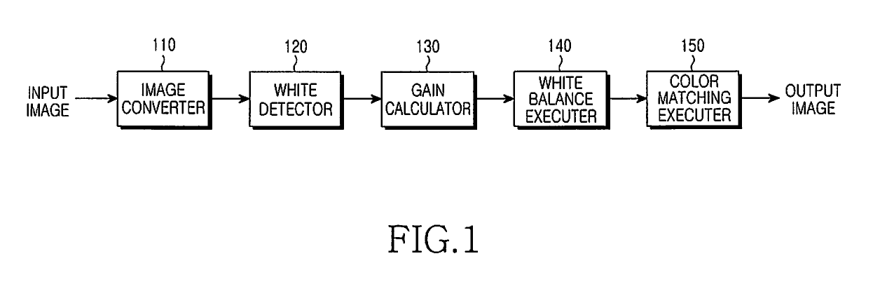

Referring initially to FIG. 1, a block diagram illustrates a white balance adjustment apparatus, according to an embodiment of the present invention. The apparatus includes an image converter 110, a white detector 120, a gain calculator 130, a white balance executer 140, and a color matching executer 150.

The image converter 110 converts an input image into a form of a YCbCr color space using Red (R), Green (G) and Blue (B) values of each pixel of the input image. Equation (1) is used for the RGB-to-YCbCr conversion.

Y=0.2990×R+0.5870×G+0.1140×B

Cb=−0.1687×R−0.3313×G+0.5000×B

Cr=0.5000×R−0.4187×G−0.0813×B (1)

R, G and B represent R, G and B pixel values of a particular pixel, Y represents a luminance component, and Cb and Cr represent color difference components.

The white detector 120 detects white pixels based on image information that is converted into the YCbCr color space by the image converter 110.

The white detector 120 models a linear function graph of chrominance |Cb|+|Cr| versus luminance Y for each of 6 gray patches at the bottom of 24 patches of a Macbeth color checker. The Macbeth color checker is a test chart that is shown by reference numeral 800 in FIG. 8 and is generally used to measure a chroma level of an image.

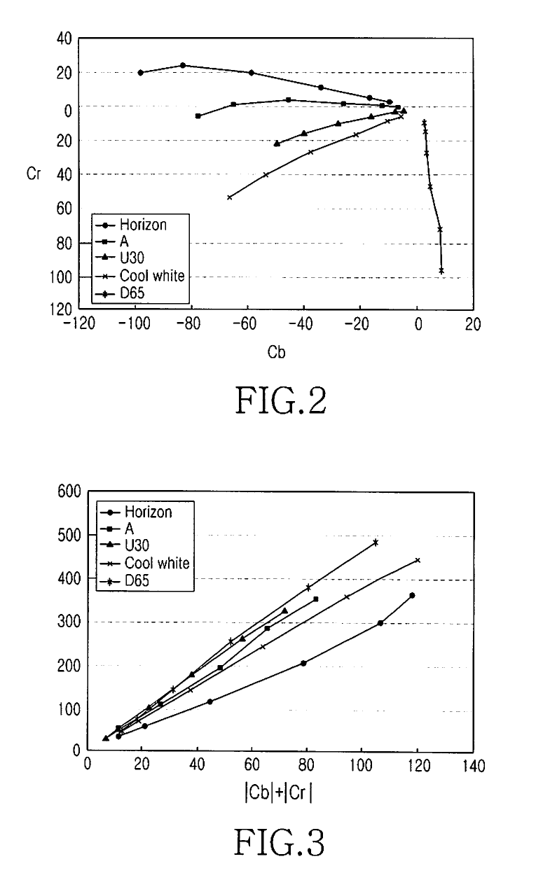

FIG. 2 is a graph illustrating a relation between chrominance Cb and Cr of an image obtained by photographing gray patches of a Macbeth color checker for each light source, according to an embodiment of the present invention. The 6 gray patches are photographed at each light source by a Complementary Metal-Oxide Semiconductor (CMOS) sensor, and converted into a YCbCr color space, and then shown on a CbCr plane for each of the light sources. In an embodiment of the present invention, five light sources are used, namely Horizon, A, U30, Cool white, and D65. Curves representing CbCr of the 6 gray patches for the five light sources are shown from the left top to the right bottom in order of Horizon, A, U30, Cool white, and D65.

The further a curve is from the gray axis (Cb=Cr=0), the greater the luminance. Thus, the luminance increases with |Cb|+|Cr|. FIG. 3 is a graph illustrating a relation between chrominance |Cb|+|Cr| and luminance Y of an image obtained by photographing gray patches of a Macbeth color checker for each light source, according to an embodiment of the present invention.

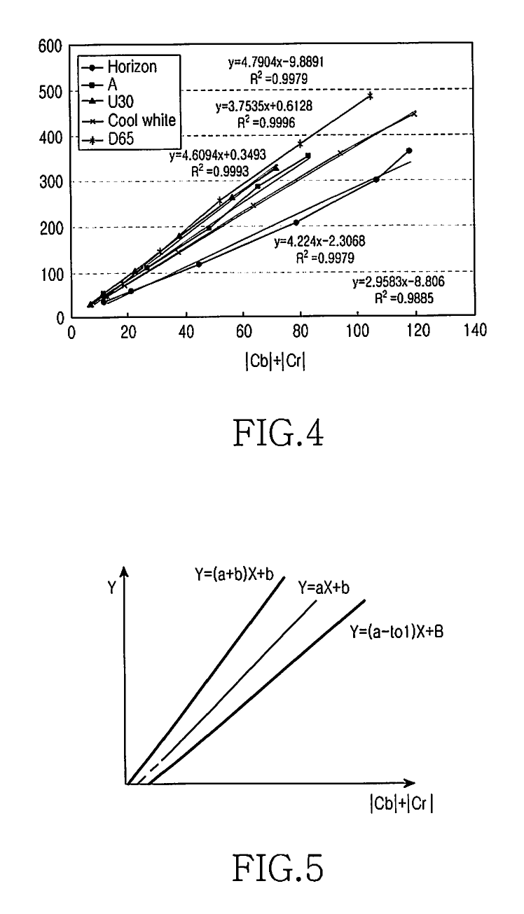

The graph of FIG. 3 can be modeled as a linear function graph, since chrominance |Cb|+|Cr| and luminance Y are proportional to each other. FIG. 4 is a linear function graph illustrating a relation between chrominance |Cb|+|Cr| and luminance Y of an image obtained by photographing gray patches of a Macbeth color checker for each light source, according to an embodiment of the present invention.

FIG. 5 is a graph illustrating a slope range where white pixels are detected in a linear function graph modeled for white detection of an image during white balance adjustment, according to an embodiment of the present invention. The white balance adjustment apparatus according to the present invention calculates two new linear function graphs having a slope determined by adding or subtracting a preset value to/from a slope of a linear function graph that is modeled for each light source. The apparatus then determines whether pixels of an input image are included in a region between the two new linear function graphs to determine whether they are white pixels. Specifically, the white balance adjustment apparatus models a Y−|Cb|+|Cr| relation of a particular light source in the form of Y=aX+b which is a linear function graph, and calculates, as shown in FIG. 5, two linear function graphs, the slopes of which are different by a preset slope value, tol, from the slope of the modeled linear function graph. If pixels of the input image are included in a region between the calculated two linear function graphs, they are determined to be white pixels.

The pixels are determined to be white pixels even when their luminance is greater than an average luminance of the input image by a preset multiple c. Such white detection is performed by Equation (2) and Equation (3).

(a−tol)(|Cb|+|Cr|)+b<Y<(a+tol)(|Cb|+|Cr|)+b (2)

‘a’ represents a slope of a modeled linear function graph indicating a Y-|Cb|+|Cr| relation of a particular light source, ‘b’ represents a y-intercept, tol represents a preset slope range, and Y represents luminance of an input image.

c Y̅<Y (3)

Y̅ represents an average luminance of an input image, and ‘c’ represents a preset constant that is multiplied by the average luminance.

Equation (2) is applied to both linear function graphs calculated for the five light sources. That is, pixels satisfying all of formulae derived from the five light sources are determined and detected as white pixels.

If R, G and B values of an input image are close to gray, i.e., if Cb and Cr of the input image are simultaneously close to zero (0), they are excluded during white detection. Thus, if absolute values of Cb and Cr of the input image are less than a preset threshold, they are excluded during white detection.

R, G and B gains that are to be used in automatic white balance adjustment are calculated with the detected white pixels. If gray pixels are included during the calculation, the image may be colored as a result of the automatic white balance. Therefore, when Equation (4) is satisfied in addition to Equation (2) or Equation (3), the pixels are determined to be white pixels.

Cb<TH or Cb>TH

Cr<TH or Cr>TH (4)

Th represents a preset threshold that is a criterion for detecting gray.

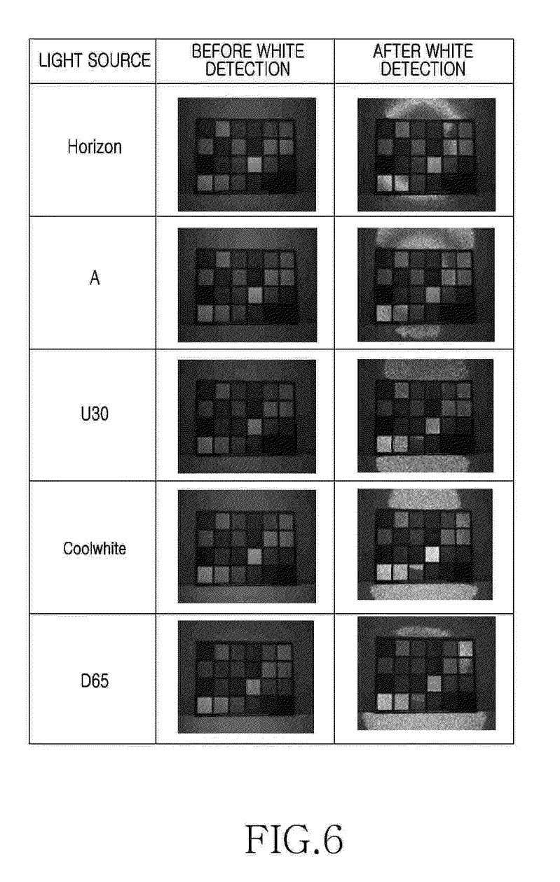

FIG. 6 is a diagram illustrating white detection results for each light source during white balance adjustment according to an embodiment of the present invention. Images before white detection and images after white detection are shown for a Macbeth color checker for each light source. In right-side images shown in FIG. 6, regions displayed in white represent regions where white pixels are detected.

Referring again to FIG. 1, the gain calculator 130 calculates R, G and B gains from R, G and B averages of the detected white pixels to perform white balance adjustment. Equation (5) is used for the gain calculation.

$${R}_{gain} = \frac{( \overline{R} + \overline{G} + \overline{B} ) / 3}{\overline{R}} \\ {G}_{gain} = \frac{( \overline{R} + \overline{G} + \overline{B} ) / 3}{\overline{G}} \\ {B}_{gain} = \frac{( \overline{R} + \overline{G} + \overline{B} ) / 3}{\overline{B}} \qquad ( 5 )$$

R̅ represents an average of R values of white pixels detected by the white detector 120, G̅ represents an average of G values of the white pixels, B̅ represents an average of B values of the white pixels, R_{gain} represents an R gain, G_{gam} represents a G gain, and B_{gain} represents a B gain.

The white balance executer 140 performs white balance adjustment using the R, G and B gains calculated by Equation (4). The white balance adjustment is performed by applying Equation (6) to all pixels of the input image.

R′=R×R_{gain}

G′=G×G_{gain}

B′=B×B_{gain} (6)

R′, G′ and B′ are pixel values that underwent white balance adjustment.

The color matching executer 150 applies a color matching matrix to the image that underwent white balance adjustment.

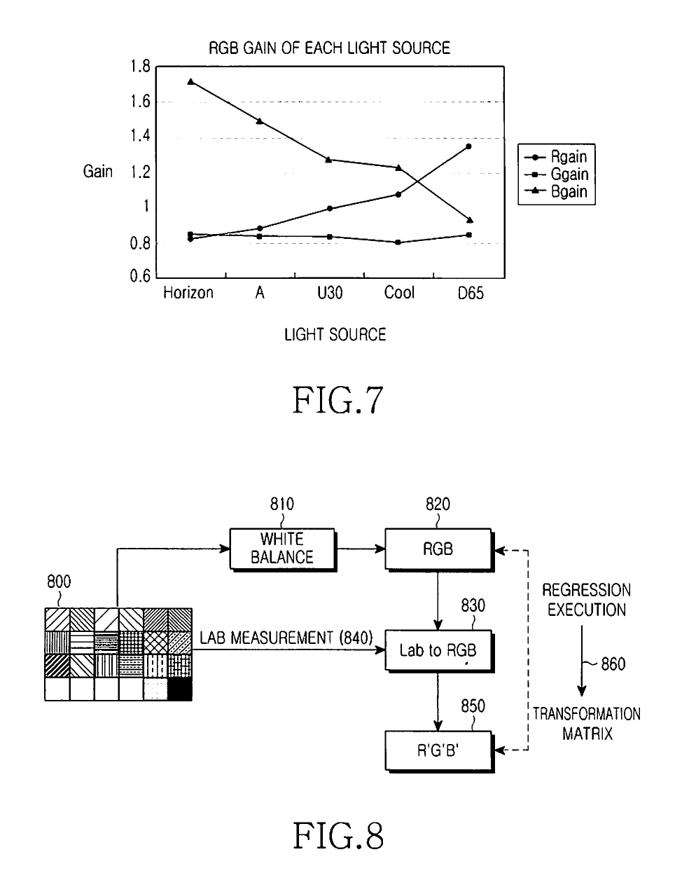

FIG. 7 is a graph illustrating R, G and B gains of each light source, according to an embodiment of the present invention. The R gain and B gain have different values according to light sources, while the G gain shows a similar value regardless of the light source. Hence, the R gain or the B gain can be used to distinguish the light sources.

After the white balance executer 140 performs white balance, the color matching executer 150 applies a matrix for color matching the white balance results.

Referring now to FIG. 8, a diagram illustrates a process of making a color matching matrix applied during white balance adjustment, according to an embodiment of the present invention.

To calculate a color matching matrix, the white balance adjustment apparatus performs white balance adjustment in step 810 after photographing a Macbeth color checker 800 at five light sources of Horizon, A, U30, Cool white, and D65. R, G and B values of each patch are acquired in step 820.

The white balance adjustment apparatus measures a Lab of 24 patches in step 840. The “Lab” represents a value of a Lab color space, which is a standard of a color space and is represented in color coordinates or stereographic coordinates of L*, a*, b*. L* indicates lightness, a* represents a level of Red and Green, and b* represents a level of Yellow and Blue.

The white balance adjustment apparatus expresses the measured Lab in the RGB form in step 830, and converts R, G and B into R′, G′, and B′ in step 850. A matrix that undergoes linear transformation from R, G and B of each patch acquired after execution of white balance to R′, G′, and B′ converted from the Lab, becomes a color matching matrix in step 860. Because every light source has a different color, the white balance adjustment apparatus independently calculates a color matching matrix for each light source, and may perform regression analysis to calculate the color matching matrix.

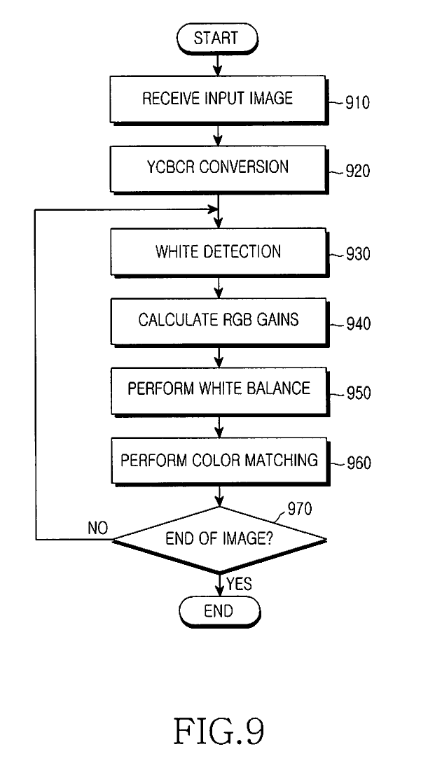

Referring to FIG. 9, a flowchart illustrates a white balance adjustment method, according to an embodiment of the present invention. An input image is received in step 910, and the input image is converted into a YCbCr color space using R, G and B values of the input image in step 920. In step 930, white pixels of the input image are detected. The white pixel detection includes modeling a linear function graph showing a Y−|Cb|+|Cr| relation of each light source for 6 gray patches at the bottom of 24 patches of the Macbeth color checker. Two linear function graphs are calculated, the slopes of which are different by a preset value from a slope of the linear function graph modeled for each light source. Pixels of the input image are determined to be white pixels if the pixels are included in a region between the two calculated graphs. The pixels of the input image are included in the region between two graphs newly calculated for all light sources. If a luminance of the pixels of the input image is greater than an average luminance of the entire input image by a particular multiple or more, they are determined to be white pixels. However, gray pixels of the input image, having a Cb and Cr of which are close to 0, are excluded during white pixel detection.

In step 940, R, G and B gains are calculated from the R, G and B averages of the white pixels detected in step 930. In step 950, white balance adjustment is performed using the R, G and B gains calculated in step 940. In step 960, light sources are distinguished using the R gain and/or B gain of the image, and color matching is performed by applying a color matching matrix corresponding to the light source. The color matching matrix for each light source is calculated in accordance with the process described in FIG. 8.

As is apparent from the foregoing description, the embodiments of the present invention perform white balance adjustment in accordance with the process described above, thereby minimizing color distortion caused by the light sources and thus improving image quality.

Also, the embodiments of the present invention can improve performance of white balance adjustment by detecting white regions of an image, thereby making it possible to minimize color distortion caused by light sources and improve the image quality.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method for adjusting white balance of a digital image, comprising the steps of:
converting an input image into a YCbCr color space;
detecting white pixels of the converted input image by determining whether each pixel of the converted input image is included in a preset region of the YCbCr color space;
calculating a gain of each channel from averages of R, G and B values of the detected white pixels; and
performing white balance adjustment by applying the calculated gain of each channel to each pixel of the input image.

2. The method of claim 1, further comprising:
distinguishing a light source for the input image using a gain of a specific channel from among the gains of each of the channels; and
performing color matching by applying a color matching matrix corresponding to the distinguished light source.

3. The method of claim 1, wherein the input image is converted in accordance with the following equation:
Y=0.2990×R+0.5870×G+0.1140×B
Cb=−0.1687×R−0.3313×G+0.5000×B
Cr=0.5000×R−0.4187×G−0.0813×B
where R, G and B represent respective R, G and B pixel values of a particular pixel, Y represents a luminance component, and Cb and Cr represent color difference components.

4. The method of claim 1, wherein detecting the white pixels comprises:
converting an image obtained by photographing gray patches of a Macbeth color checker for each light source into the YCbCr color space;
modeling each converted image as a linear function graph representing a relation between chrominance |Cb|+|Cr| and luminance Y;
calculating two linear function graphs for each light source, wherein slopes of each of the two linear function graphs differ from a slope of the modeled linear function graph by a preset slope value;
determining whether pixels of the input image are included in a region between the two linear function graphs calculated for each light source; and
defining the pixels of the input image that are included in the region between the two linear function graphs calculated for each light source as white pixels.

5. The method of claim 4, further comprising determining the pixels of the input image as white pixels, when a luminance of the pixels of the input image is greater than an average luminance of all pixels of the input image by at least a preset multiple.

6. The method of claim 5, further comprising determining that a pixel having absolute values of a Cb value and a Cr value that are less than a preset threshold, among the pixels defined as white pixels, is not a white pixel.

7. The method of claim 1, wherein the channel gain is calculated in accordance with the following equation:
$${R}_{gain} = \frac{( \overline{R} + \overline{G} + \overline{B} ) / 3}{\overline{R}}$$
$${G}_{gain} = \frac{( \overline{R} + \overline{G} + \overline{B} ) / 3}{\overline{G}}$$
$${B}_{gain} = \frac{( \overline{R} + \overline{G} + \overline{B} ) / 3}{\overline{B}}$$
where R̅ represents an average of R values of the detected white pixels, G̅ represents an average of G values of the detected white pixels, B̅ represents an average of B values of the detected white pixels, R_{gain} represents an R gain, G_{gain} represents a G gain, and B_{gain} represents a B gain.

8. The method of claim 1, wherein white balance adjustment is performed in accordance with the following equation:
R′=R×R_{gain}
G′=G×G_{gain}
B′=B×B_{gain}
where R′, G′ and B′ represent pixel values obtained by performing white balance, R_{gain} represents an R gain, G_{gain} represents a G gain, and B_{gain} represents a B gain.

9. The method of claim 2, wherein the gain of the specific channel is an R gain or a B gain.

10. The method of claim 2, wherein the color matching matrix is calculated by performing white balance after photographing a Macbeth color checker for each light source, acquiring first R, G and B values of each patch of the Macbeth color checker, measuring a Lab of each patch, converting the measured Lab into second R, G and B values, and linearly converting a space between the first R, G and B values and the second R, G and B values.

11. The method of claim 4, wherein the light sources comprise Horizon, A, U30, Cool white, and D65.

12. An apparatus for adjusting white balance of a digital image, comprising:
an image converter for converting an input image into a YCbCr color space;
a white detector for detecting white pixels of the converted input image by determining whether each pixel of the converted input image is included in a preset region of the YCbCr color space;
a gain calculator for calculating a gain of each channel from averages of R, G and B values of the detected white pixels; and
a white balance executer for performing white balance adjustment by applying the calculated gain of each channel to each pixel of the input image.

13. The apparatus of claim 12, further comprising a color matching executer for distinguishing a light source for the input image using a gain of a specific channel from among the gains of each of the channels, and performing color matching by applying a color matching matrix corresponding to the distinguished light source.

14. The apparatus of claim 12, wherein the image converter converts the input image in accordance with the following equation:
Y=0.2990×R+0.5870×G+0.1140×B
Cb=−0.1687×R−0.3313×G+0.5000×B
Cr=0.5000×R−0.4187×G−0.0813×B
where R, G and B represent respective R, G and B pixel values of a particular pixel, Y represents a luminance component, and Cb and Cr represent color difference components.

15. The apparatus of claim 12, wherein the white detector converts an image obtained by photographing gray patches of a Macbeth color checker for each light source into the YCbCr color space, models each converted image as a linear function graph representing a relation between chrominance |Cb|+|Cr| and luminance Y, calculates two linear function graphs for each light source, wherein slopes of each of the two linear function graphs differ from a slope of the modeled linear function graph by a preset slope value, determines whether pixels of the input image are included in a region between the two linear function graphs calculated for each light source, and defines the pixels of the input image that are included in the region between the two linear function graphs calculated for each light source as white pixels.

16. The apparatus of claim 15, wherein the white detector determines the pixels of the input image as white pixels, when a luminance of the pixels of the input image is greater than an average luminance of all pixels of the input image by at least a preset multiple.

17. The apparatus of claim 16, wherein the white detector determines that a pixel having absolute values of a Cb value and a Cr value that are less than a preset threshold, among the pixels defined as white pixels, is not a white pixel.

18. The apparatus of claim 12, wherein the gain calculator calculates the gain of each channel in accordance with the following equation:
$${R}_{gain} = \frac{( \overline{R} + \overline{G} + \overline{B} ) / 3}{\overline{R}}$$
$${G}_{gain} = \frac{( \overline{R} + \overline{G} + \overline{B} ) / 3}{\overline{G}}$$
$${B}_{gain} = \frac{( \overline{R} + \overline{G} + \overline{B} ) / 3}{\overline{B}}$$
where R̅ represents an average of R values of the detected white pixels, G̅ represents an average of G values of the detected white pixels, B̅ represents an average of B values of the detected white pixels, R_{gain} represents an R gain, G_{gain} represents a G gain, and B_{gain} represents a B gain.

19. The apparatus of claim 12, wherein the white balance executer performs white balance adjustment in accordance with the following equation:
R′=R×R_{gain}
G′=G×G_{gain}
B′=B×B_{gain}
where R′, G′ and B′ represent pixel values obtained by performing white balance, R_{gain} represents an R gain, G_{gain} represents a G gain, and B_{gain} represents a B gain.

20. The apparatus of claim 13, wherein the gain of the specific channel is an R gain or a B gain.

21. The apparatus of claim 13, wherein the color matching matrix is calculated by performing white balance after photographing a Macbeth color checker for each light source, acquiring first R, G and B values of each patch of the Macbeth color checker, measuring a Lab of each patch, converting the measured Lab into second R, G and B values, and linearly converting a space between the first R, G and B values and the second R, G and B values.

22. The apparatus of claim 15, wherein the light sources comprise Horizon, A, U30, Cool white, and D65.
